(19) United States
(12) Patent Application Publication
(10) Pub. No.: US 2017/0293593 A1
(43) Pub. Date: Oct. 12, 2017

(54) MANAGING NODE PAGINATION FOR A GRAPH DATA SET

(71) Applicant: INTERNATIONAL BUSINESS MACHINES CORPORATION, Armonk, NY (US)

(72) Inventors: Douglas J. Cowie, Bishopstoke (GB); Anthony A. Garrard, Bournemouth (GB); Jonathan Limburn, Southampton (GB); Nicolas S. Townsend, Southampton (GB)

(21) Appl. No.: 15/096,547

(22) Filed: Apr. 12, 2016

(51) Int. Cl. G06F 17/21; G06F 3/0482; G06F 3/0483; G06F 17/30

(52) U.S. Cl. CPC G06F 17/217; G06F 17/30902; G06F 3/0482; G06F 3/0483

(57) ABSTRACT

Method and system are provided for managing node pagination for a graph data set. A content controller receives a request for one or more pages of a node for display at the user interface; retrieving the one or more pages of the node from a backing store of the graph data set; caching the one or more pages at the content controller; and returning the one or more pages to the user interface for loading and display. In response to de-selection of one or more pages in the display, the method may hide the pages of data for the node by un-loading the pages from the display whilst maintaining the pages in the cache. In response to re-selection of one or more pages in the display, the method may retrieve the pages from the cache and re-loading the pages in the display.

### BACKGROUND

The present invention relates to managing node pagination for a graph data set, and more specifically, to managing node pagination for views of a graph data set.

When loading large data sets for a user to view, there can be a need to limit the size of the data set returned to improve performance and avoid overloading the user with the data.

Graph data sets use a mathematical graph of nodes and links to represent data items and relationships. With graph data sets represented by nodes and links, there are node-centric approaches to loading parts of the data set that relate to a particular node, rather than linearly loading the data set. Additionally, when exploring a graph, once part of the data has been loaded, if it is not relevant it may need to be discarded from the view.

Pagination is a known concept when loading data, providing a mechanism to load “pages” of data on demand instead of the whole data set. For example, transactions may include page start and end parameters to control the size of the result set. FACEBOOK'S® Graph application programming interface (API) provides a similar pagination mechanism for loading nodes and links from their graph store. However, these APIs are for loading the data from a backing data store; they do not address controls for the user to load and hide pages.

Therefore, there is a need in the art to address the aforementioned problems.

### BRIEF SUMMARY

Additional aspects and/or advantages will be set forth in part in the description which follows and, in part, will be apparent from the description, or may be learned by practice of the invention.

According to a first aspect of the present invention there is provided a computer-implemented method for managing node pagination for a graph data set carried out at a content controller, the method comprising: receiving, by a content controller, a request from a user computing device for one or more pages of a node to be display at a user interface; retrieving, by the content controller, the one or more pages of the node from a backing store of a graph data set; caching, by the content controller, the one or more pages; returning, by the content controller, the one or more pages to the user interface for loading and display; in response to de-selection of one or more pages in the display at the user interface, hiding the pages of data for the node and un-loading the pages from the display at the user interface whilst maintaining the pages in the cache; and in response to re-selection of one or more pages in the display at the user interface, retrieving the pages from the cache and re-loading the pages in the display at the user interface.

The described aspects of the invention provide the advantage of providing a mechanism for the user to load and hide specific and discrete parts of the data set that they are interested in while exploring the data.

Using caching of page data for each node at a content controller, enables pages of data to be selectively displayed with good response times and decreases network traffic.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram of an example embodiment of a system in accordance with the present invention;

FIG. 2 is an example embodiment of a user interface control in accordance with an aspect of the present invention;

FIG. 3 is a flow diagram of an example embodiment of an aspect of a method in accordance with the present invention as carried out by a content controller;

FIG. 4A and FIG. 4B are flow diagrams of example embodiments of further aspects of a method in accordance with the present invention as carried out by a user interface;

FIG. 5 is a diagram of an example embodiment of a system in accordance with the present invention;

FIG. 6 is a diagram of an embodiment of a computer system or cloud server in which the present invention may be implemented;

FIG. 7 is a schematic diagram of a cloud computing environment in which the present invention may be implemented; and

FIG. 8 is a diagram of abstraction model layers of a cloud computing environment in which the present invention may be implemented.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Reference will now be made in detail to the embodiments of the present invention, examples of which are illustrated in the accompanying drawings, wherein like reference numerals refer to like elements throughout.

Managing node pagination for a large graph data set is described. A user interface display may load nodes and links from a graph data set at a backing store. The described mechanism provides a content controller via which a user viewing the data on a user interface may load or hide discrete parts of a data set provided by a backing store.

The proposed content controller provides a mechanism for independent pagination/loading of nodes within the graph data set. This allows a user to explore a graph data set by paginating individual nodes to load their pages of data. The loading of each node's pages is independent from all other nodes; so while one node may have loaded two pages of data, another may already have four pages of data loaded. Additionally, pages do not have to be loaded sequentially, instead they may be loaded in the order requested by the user.

The proposed mechanism may be build upon pagination APIs for loading data; if a page has not yet been loaded the request for the page may be sent using a pagination API. However, the mechanism of the content controller sits as a layer above the backing store; providing control to the user to select which page or pages to be loaded, and may maintain an internal copy to avoid re-loading data. This also allows the capability to return “sets” of pages, so that a user can later hide a previously loaded page from their view of the node.

Whenever a page of data is requested for viewing by a user from the content controller that has not yet been loaded, a request is made to the backing store using a pagination API. When the data is returned, the proposed mechanism at the content controller maintains an internal copy of pages for each node in the data set.

The user interface provides the capability to request individual pages for the node, a collection of pages, or the whole node. The requested pages can be non-sequential, and so any view that is built to consume the data can use the mechanism to refresh its view of the data to hide/show pages for each of the nodes.

A user may select sections of the node (for example, by pointer selection or clicking in the user interface) to hide/show that page of data for the node in the view. This may instruct the loading of the related links/nodes for that page of data in the graph. The view may be populated incrementally by paging nodes. However, if the graph becomes saturated, the loaded links/nodes for the page may be hidden from the view by selecting or clicking on the page sections for a node or an entire node in order to hide it from view. This is valuable from a performance perspective for loading data, but also makes the graph view more usable by providing the ability to hide sections of the view.

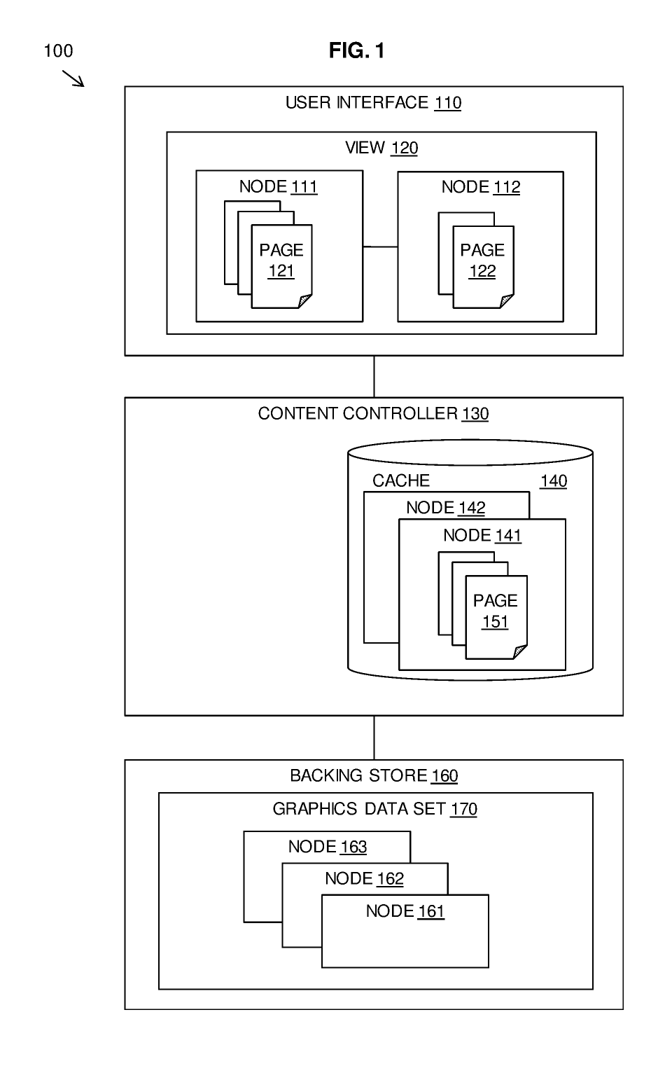

Referring to FIG. 1, is a block diagram of an example embodiment of a system 100, in accordance with the present invention. A content controller 130 is provided for managing node pagination for viewing a large graphics data set 170 provided by a backing store 160 in a view 120 provided by a user interface 110. A graphics data set 170 provided at a backing store 160 may be formed of nodes 161 to 163 which may be formed of multiple pages. In one example, a graphics data set 170 may include nodes of items or things, such as photographs, comments, users which are connected by edges which define relationships between the nodes.

A user may interact with a user interface 110 at a client system showing a view 120 of the data set. A summary display of a graph data set or a portion thereof may be provided by the user interface 110. Nodes 111, 112 and pages 121, 122 may be loaded by the user interface 110 for display in the view 120 upon selection by a user. The user interface 110 may render the nodes in the view as specified in the summary.

The view 120 may provide controls for the user to load selected individual or groups of pages 121, 122 from nodes 111, 112 of the graphics data set 170 of the backing store 160 via use of the content controller 130. The content controller 130 may receive page or whole node requests from the user interface 110.

Multiple user interfaces 110 provided at client systems may use the content controller 130 to enable user control of the data to be viewed. The content controller 130 may be provided remotely as a cloud service.

The content controller 130 maintains a cache 140 of pages 151 of nodes 141, 142 which have already been retrieved from the graphics data set 170 of the backing store 160. When the content controller 130 receives a request for a set of pages from the user interface for display, it may check the contents of the cache 140 and may provide the pages if they are already cached. It the pages are not cached, the content controller 130 may request the pages from the backing store 160, either as a whole node containing the set of pages or as just the set of pages. The content controller 130 may cache the retrieved pages in the cache 140 and may load the requested set of pages to the user interface for viewing in the view 120.

The user may interact with the user interface 110 to hide a set of pages or node in the view 120. The content controller 130 may keep these pages in the cache 140 whilst unloading them from the view 120 of the user interface 110. As the pages hidden from the view 120 in the user interface 110 are stored in the cache 140 of the content controller 130, these may be retrieved if re-selected by the user without having to fetch them from the backing store 160 minimizing network traffic.

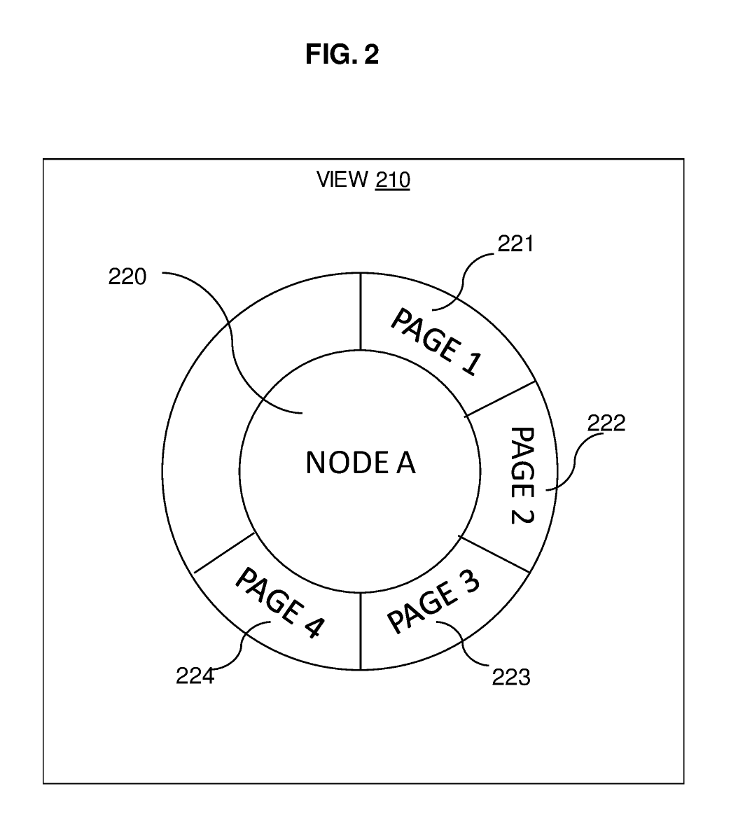

Referring to FIG. 2, an example is shown of a graphical representation of a node 220 which may be provided for each node in the view 210 of the user interface 110. The graphical representation 220 may have a graphical indication of the pages 221-224 of the node 220. The graphical indication of the pages 221-224 may be selected for loading and view by a user input associated with the indications. For example, by clicking a cursor on a page indication. A user input may also de-select one or more pages from the view resulting in the data being unloaded from the user interface 110.

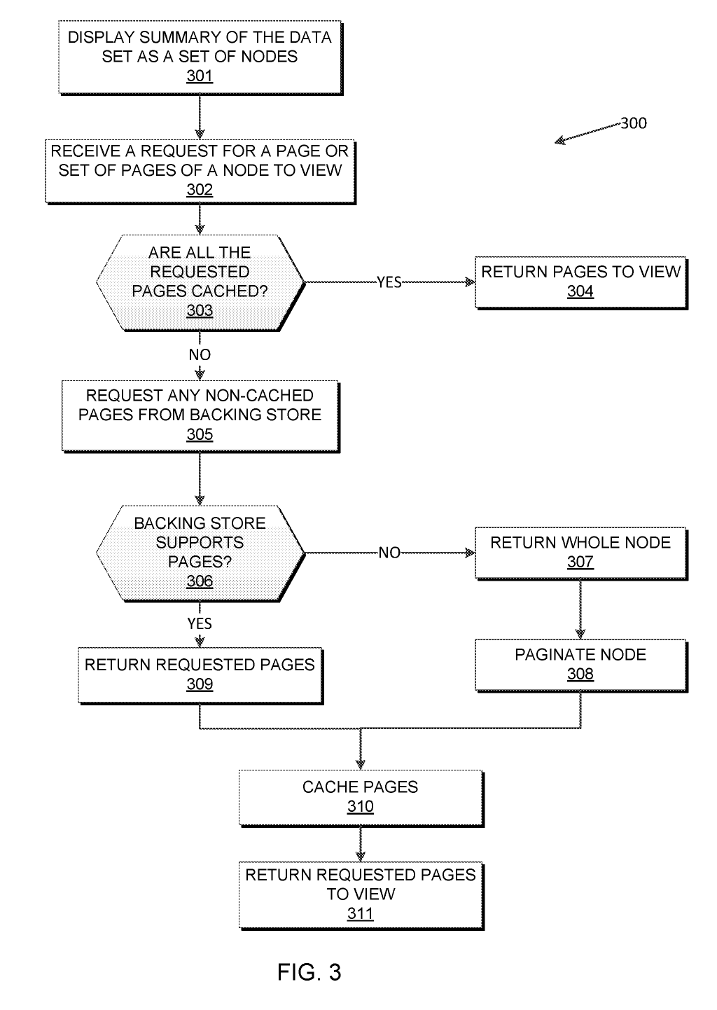

Referring to FIG. 3, a flow diagram 300 shows an example embodiment of an aspect of the described method. The described method is carried out at a content controller 130 receiving user input from a user interface 110, which may display 301 a summary of a graph data set including representations of at least some of the nodes of the graph data set. The summary of the data set may be provided as a set of nodes and links which the user interface may render the nodes as these are loaded and may draw links between each node as specified in the summary.

The content controller 130 may receive 302 a request from a user interface 110 for a set of pages 121, 122 of a node 111, 112 to view 120. The set of pages 121, 122 may include one or more pages 121, 122 of the node 111, 112, which may be in sequential order, or may be in an order selected by the user. The set of pages may alternatively be an entire node 111, 112.

The content controller 130 may ascertain if all the requested pages are cached 303 in the content controller's cache 140. If all the pages are already cached 304, then the content controller 130 may load the pages for view 120 in the display of the user interface 110.

If one or more of the pages are not cached, the content controller 130 may request 305 the required pages from the backing store 160 at which the graph data set is stored. This may be done in various different manners depending on whether the backing store 160 supports pagination. It is therefore determined if the backing store supports 306 retrieval of pages. If it does support retrieval of individual pages, the requested pages may be returned 309 from the backing store. However, if it does not support retrieval of individual pages, the whole node in which the requested pages are located may be returned 307 from the backing store 160. The content controller 130 may then paginate 308 the node to extract the individual or range of requested pages.

The returned pages may be cached 310 at the content controller. The content controller may store, either all the pages of the node retrieved from the backing store or only the pages of the node requested by the user.

The requested pages may be returned 311 to the user interface by loading them in the view.

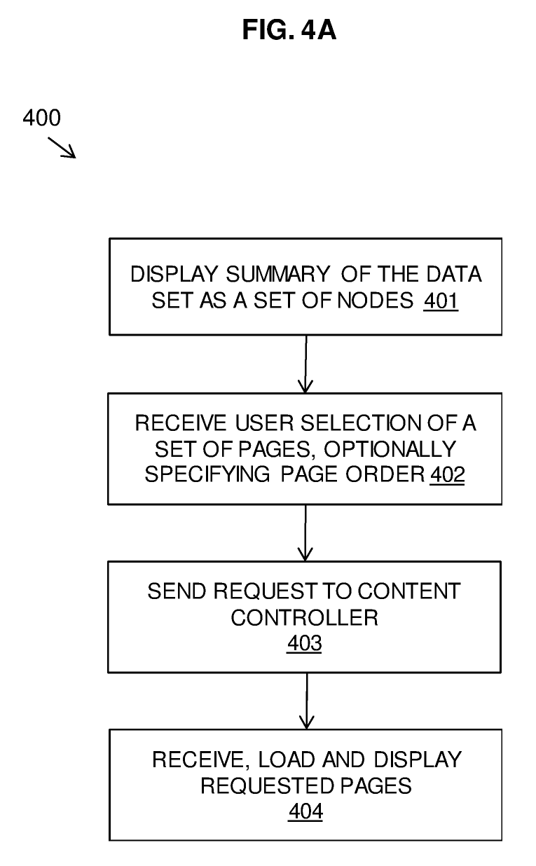

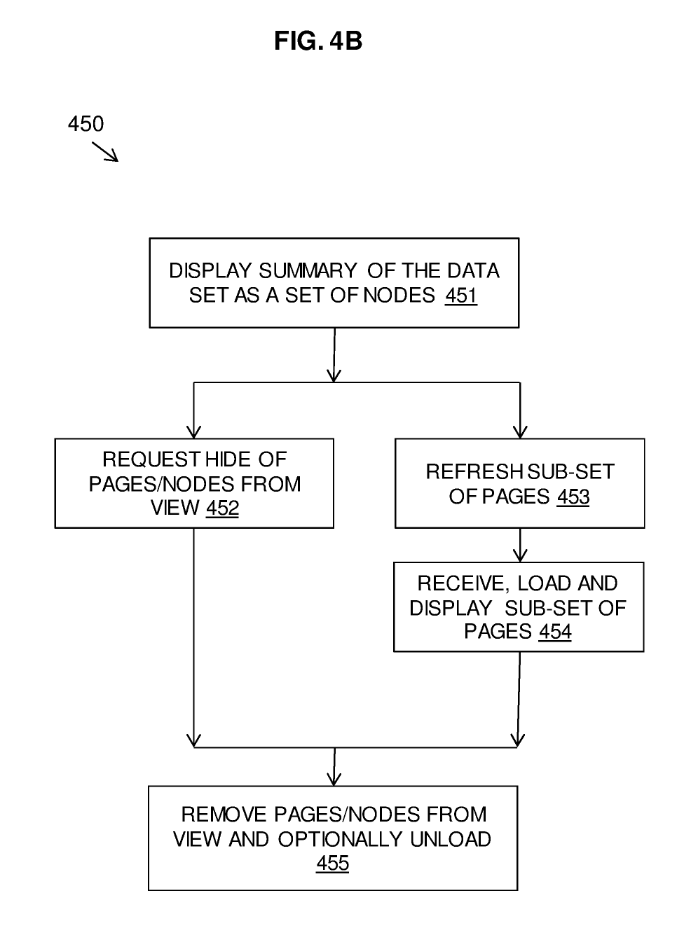

Referring to FIGS. 4A and 4B flow diagrams 400, 450 show example embodiments of aspects of the described method carried out by the user interface. The user interface 110 which may display 401 a summary of a graph data set including representations of at least some of the nodes 111, 112 of the data set.

The user interface 110 may receive 402 a user selection of a set of pages 121, 122 for display. The user selection may be received by a user interface input in relation to a graphical representation of a node such as that shown in FIG. 2. The user selection may be a set of pages 121, 122 in a specified order or in a sequential order. The user selection may be an entire node 111, 122 or selected pages from a node 111, 112.

A request for the set of pages may be sent 403 to the content controller 130. The user interface 110 may receive, load and display 404 the requested pages 121, 122.

Referring to FIG. 4B, the user interface 110 may display 451 a summary of a graph data set including representations of at least some of the nodes of the data set as well as at least some portions of the graph data set that are loaded for full display.

The user interface 110 may receive 452 a user request to hide selected pages or nodes from the view in the display. This may be received by a user input in relation to pages or nodes for de-selection.

Alternatively, the user interface 110 may receive 453 a refresh request for a selection of pages that is a subset of previously selected pages. The requested sub-set may be received, loaded and displayed 454 replacing previously displayed pages.

Pages that have been requested to be hidden by de-selection by the user or by not being included in a sub-set request, may be hidden from view 455, and optionally unloaded from the user interface. The unloading may take place for all hidden pages, or may take place as required for performance at the user interface.

The user interface 110 may show or hide pages as required. The content controller 130 may return the pages requested by the user interface 110 and the user interface 110 may then hide/show these visually as required. For example, pages 1, 2, 3 may be requested for a node and the user interface 110 may maintain their own copy of the pages. It may hide these pages itself and only request new pages from the content controller 130. Alternatively, the user interface 110 may refresh itself using the content controller 130, for example, by requesting pages 1, 2, 3 and rendering the user interface 110, then requesting pages 2, 3 and rendering the user interface 110, thus hiding page 1.

The content controller 130 provides methods for a view to request a node, optionally including page numbers with the request. The content controller 130 may then request the required pages or whole node from the backing store and return it to the view. The pages loaded for the node are cached 140 inside the content controller 130, so that later requests for a page may be returned from the cache 140 rather than the backing store 160. When a request is sent from the view containing pages numbers that both have and have not been loaded, the content controller 130 may only request the additional pages from the backing store and then return the full set of pages. Additionally, if the backing store does not support pagination, the content controller 130 can request the whole node from the backing store 160, and then split the result set into pages to enable the hide/show capability.

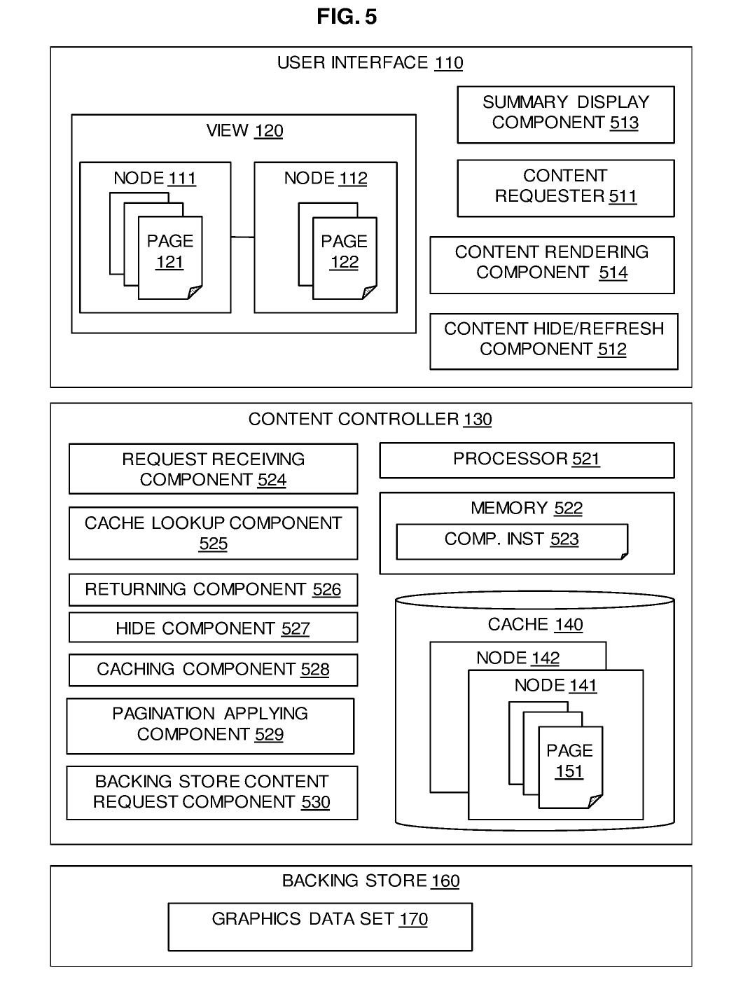

Referring to FIG. 5, a block diagram shows an example embodiment of the described system 100, which may include a content controller 130 provided as a layer above a backing store 160 providing a large graphics data set 170. The content controller 130 may provide control of loading and viewing of nodes 111, 112 and individual pages 121, 122 of the graphics data set 170 at a view 120 provided by a user interface 110 which may be provided remotely at one or more client systems.

The content controller 130 may include at least one processor 521, a hardware module, or a circuit for executing the functions of the described components which may be software units executing on the at least one processor. Multiple processors running parallel processing threads may be provided enabling parallel processing of some or all of the functions of the components. Memory 522 may be configured to provide computer instructions 523 to the at least one processor 521 to carry out the functionality of the components.

The user interface 110 may include a content requester 511 for requesting the loading of one or more pages of a node or a complete node of a data set from the content controller 130. The user interface 110 may include a summary display component 513 for providing a summary display of at least a portion of a graph data set including representations of nodes and pages within the nodes, for example as shown in FIG. 2, which may provide a selection tool for the user to request specific pages of content. The pages may be selected for request in a specified order. Multiple requests of pages may be made independently from different nodes of the data set.

The user interface 110 may include a content rendering component 514 for rendering the received pages for display at the user interface. The user interface 110 may also include a content hide/refresh component 512 for hiding de-selected pages.

The content controller 130 may include a request receiving component 524 which may receive a request for content of the data set such as a set of pages or a node from the selection made at the user interface 110. The content controller 130 may provide a pagination API for use by a client system providing a user interface. The pagination API enables user interfaces or other systems to request and consume individual pages or nodes of the graph data set.

The content controller 130 may include a cache lookup component 525 for looking up the requested pages in a page cache 140 at or accessible to the content controller 130 which may cache already retrieved nodes 141, 142 and pages 151 of the graphics data set 170 of the backing store 160.

The content controller 130 may include a backing store content request component 530 for requesting content in the form of pages or nodes from the graphics data set 170 of the backing store 160. If the backing store 160 supports pagination, individual pages may be retrieved. However, if the backing store 160 does not support pagination, an entire node may be retrieved and a pagination applying component 529 may be provided at the content controller 130 for paginating the node. The backing store 160 may provide a content API such as a pagination API for the content controller to use to retrieve content.

The content controller 130 may include a caching component 528 for caching pages or nodes retrieved from the backing store 160 at the cache 140 of the content controller 130. A returning component 526 may return the set of pages or node requested by the selection made at the user interface 110 and received at the request receiving component 524 by loading the content into the view 120. The set of pages or node may be returned as retrieved from the cache 140 or as retrieved from the backing store 160, or a combination of the two.

The content controller 130 may include a hide component 527 for receiving a selection made at the user interface 110 to hide content in the form of a set of pages or node from the view 120. A hide request may be received at the content controller 130 at the request receiving component 524. A hide request may result in the content being unloaded from the user interface view 120 while being maintained in the cache 140.

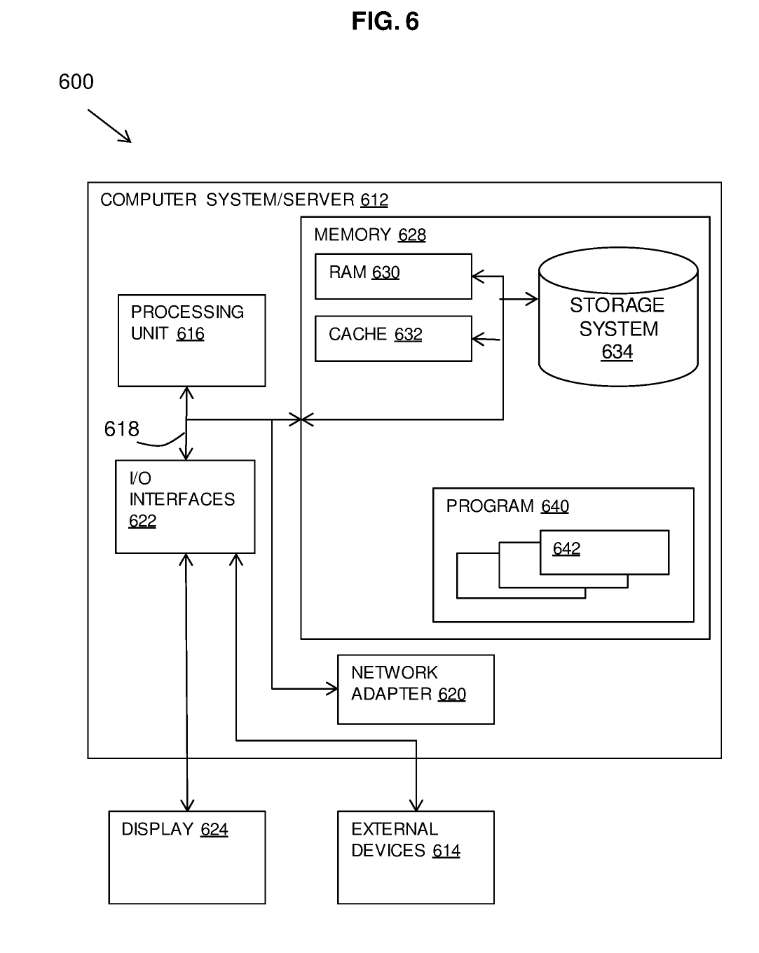

Referring now to FIG. 6, a schematic of an example of a system 600 in the form of a computer system or server is shown in which aspects of the described system may be implemented such as the content controller 130.

A computer system or server 612 may be operational with numerous other general purpose or special purpose computing system environments or configurations. Examples of well-known computing systems, environments, and/or configurations that may be suitable for use with computer system/server 612 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 612 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 612 may be practiced in distributed cloud computing environments where tasks are performed by remote processing devices that are linked through a communications network. In a distributed cloud computing environment, program modules may be located in both local and remote computer system storage media including memory storage devices.

In FIG. 6, a computer system/server 612 is shown in the form of a general-purpose computing device. The components of the computer system/server 612 may include, but are not limited to, one or more processors or processing units 616, a system memory 628, and a bus 618 that couples various system components including system memory 628 to processor 616.

Bus 618 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 612 typically includes a variety of computer system readable media. Such media may be any available media that is accessible by computer system/server 612, and it includes both volatile and non-volatile media, removable and non-removable media.

System memory 628 can include computer system readable media in the form of volatile memory, such as random access memory (RAM) 630 and/or cache memory 632. Computer system/server 612 may further include other removable/non-removable, volatile/non-volatile computer system storage media. By way of example only, storage system 634 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 618 by one or more data media interfaces. As will be further depicted and described below, memory 628 may include at least one program product having a set (e.g., at least one) of program modules that are configured to carry out the functions of embodiments of the invention.

Program/utility 640, having a set (at least one) of program modules 642, may be stored in memory 628 by way of example, and not limitation, as well as an operating system, one or more application programs, other program modules, and program data. Each of the operating system, one or more application programs, other program modules, and program data or some combination thereof, may include an implementation of a networking environment. Program modules 642 generally carry out the functions and/or methodologies of embodiments of the invention as described herein.

Computer system/server 612 may also communicate with one or more external devices 614 such as a keyboard, a pointing device, a display 624, etc.; one or more devices that enable a user to interact with computer system/server 612; and/or any devices (e.g., network card, modem, etc.) that enable computer system/server 612 to communicate with one or more other computing devices. Such communication can occur via Input/Output (I/O) interfaces 622. Still yet, computer system/server 612 can communicate with one or more networks such as a local area network (LAN), a general wide area network (WAN), and/or a public network (e.g., the Internet) via network adapter 620. As depicted, network adapter 620 communicates with the other components of computer system/server 612 via bus 618. It should be understood that although not shown, other hardware and/or software components could be used in conjunction with computer system/server 612. Examples, include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Cloud Computing

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

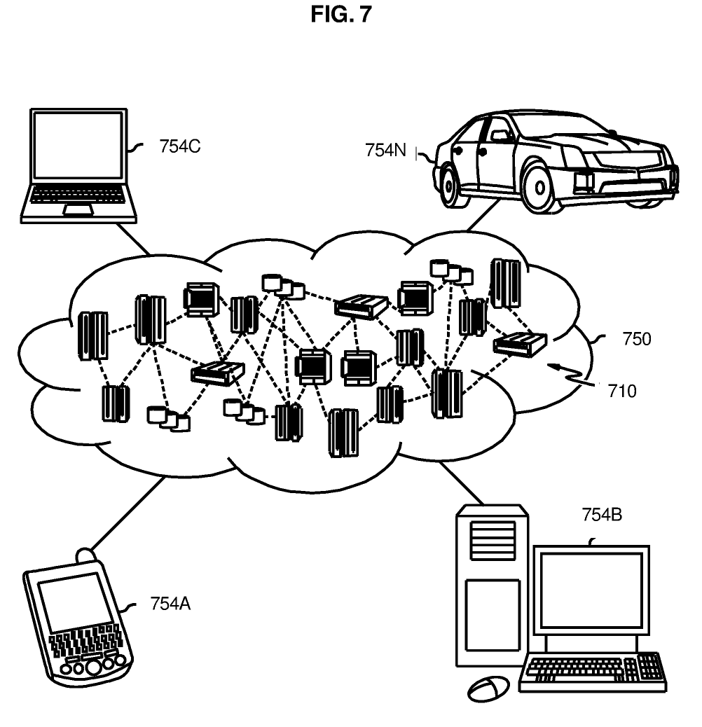

Referring now to FIG. 7, illustrative cloud computing environment 750 is depicted. As shown, cloud computing environment 750 includes one or more cloud computing nodes 710 with which local computing devices used by cloud consumers, such as, for example, personal digital assistant (PDA) or cellular telephone 754A, desktop computer 754B, laptop computer 754C, and/or automobile computer system 754N may communicate. Nodes 710 may communicate with one another. They may be grouped (not shown) physically or virtually, in one or more networks, such as Private, Community, Public, or Hybrid clouds as described hereinabove, or a combination thereof. This allows cloud computing environment 750 to offer infrastructure, platforms and/or software as services for which a cloud consumer does not need to maintain resources on a local computing device. It is understood that the types of computing devices 754A-N shown in FIG. 7 are intended to be illustrative only and that computing nodes 710 and cloud computing environment 750 can communicate with any type of computerized device over any type of network and/or network addressable connection (e.g., using a web browser).

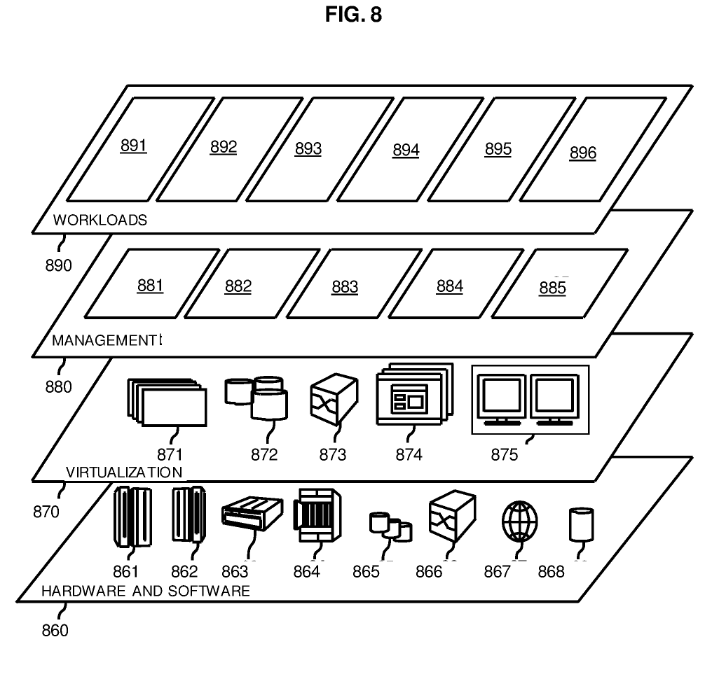

Referring now to FIG. 8, a set of functional abstraction layers provided by cloud computing environment 750 (FIG. 1) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 860 includes hardware and software components. Examples of hardware components include: mainframes 861; RISC (Reduced Instruction Set Computer) architecture based servers 862; servers 863; blade servers 864; storage devices 865; and networks and networking components 866. In some embodiments, software components include network application server software 867 and database software 868.

Virtualization layer 870 provides an abstraction layer from which the following examples of virtual entities may be provided: virtual servers 871; virtual storage 872; virtual networks 873, including virtual private networks; virtual applications and operating systems 874; and virtual clients 875.

In one example, management layer 880 may provide the functions described below. Resource provisioning 881 provides dynamic procurement of computing resources and other resources that are utilized to perform tasks within the cloud computing environment. Metering and Pricing 882 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 883 provides access to the cloud computing environment for consumers and system administrators. Service level management 884 provides cloud computing resource allocation and management such that required service levels are met. Service Level Agreement (SLA) planning and fulfillment 885 provide pre-arrangement for, and procurement of, cloud computing resources for which a future requirement is anticipated in accordance with an SLA.

Workloads layer 890 provides examples of functionality for which the cloud computing environment may be utilized. Examples of workloads and functions which may be provided from this layer include: mapping and navigation 891; software development and lifecycle management 892; virtual classroom education delivery 893; data analytics processing 894; transaction processing 895; and content control managing node pagination 896 for a graph data set.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Based on the foregoing, a computer system, method, and computer program product have been disclosed. However, numerous modifications and substitutions can be made without deviating from the scope of the present invention. Therefore, the present invention has been disclosed by way of example and not limitation.

While the invention has been shown and described with reference to certain exemplary embodiments thereof, it will be understood by those skilled in the art that various changes in form and details may be made therein without departing from the spirit and scope of the present invention as defined by the appended claims and their equivalents.

1.-12. (canceled)

13. A system for managing node pagination for a graph data set, comprising:
a content controller having processor and a memory configured to provide computer program instructions to the processor to execute the function of the components and a cache component for storing pages of nodes a data set;
a request receiving component for receiving a request from a user computing device for one or more pages of a node to be display at a user interface;
a retrieving component for retrieving the one or more pages of the node from a backing store of a graph data set;
the caching component for caching the one or more pages at the content controller;
a returning component for returning the one or more pages to the user interface for loading and display;
in response to de-selection of one or more pages in the display at the user interface, hiding the pages of data for the node and un-loading the pages from the display at the user interface whilst maintaining the pages in the cache; and
in response to re-selection of one or more pages in the display at the user interface, retrieving the pages from the cache and re-loading the pages in the display at the user interface.

14. The system as claimed in claim 13, further comprises:
a cache lookup component for checking a cache for the requested one or more pages at the content controller;
when one or more of the pages is cached, retrieving the pages from the cache; and
when one or more of the pages is not cached, retrieving the one or more pages of the node from a backing store of the data set.

15. The system as claimed in claim 13, further comprises:
a pagination applying component for paginating the node;
wherein when the backing store does not support pagination, retrieving a node from the backing store and paginating the node at the content controller.

16. The system as claimed in claim 13, further comprises:
a user interface for displaying a summary of at least a portion of the data set;
wherein the display includes a graphical representations of pages of the node; and
wherein the display includes representations of pages of the nodes for selection, de-selection and re-selection of one or more pages.

17. A computer program product for managing node pagination for a graph data set, the computer program product comprising a computer readable storage medium having program instructions embodied therewith, the program instructions executable by a processor to cause the processor to:
receive a request for one or more pages of a node for display at a user interface;
retrieve the one or more pages of the node from a backing store of the graph data set;
cache the one or more pages at the content controller;
return the one or more pages to the user interface for loading and display;
wherein responsive to de-selection of one or more pages in the display, hiding the pages of data for the node by un-loading the pages from the display whilst maintaining the pages in the cache; and
responsive to re-selection of one or more pages in the display, retrieving the pages from the cache and re-loading the pages in the display.

18. A computer-implemented method for managing node pagination for a graph data set carried out at a user interface, the method comprising:
displaying a summary of at least a portion of a data set as a set of the nodes at a user interface which includes representations of pages of the nodes for selection;
receiving a user selection of one or more pages of a node for loading and display at the user interface;
retrieving the one or more pages of the node from a content controller at which pages are cached or retrieved from a backing store;
loading and displaying the one or more pages at the user interface;
in response to de-selection of one or more pages in the display, hiding the pages of data for the node and un-loading the pages from the display at the user interface; and
in response to re-selection of one or more pages in the display, retrieving the pages from the content controller and re-loading the pages in the display at the user interface.

19. The method as claimed in claim 18, the method further comprises:
in response to refreshing of a sub-set of previously selected pages, re-loading the sub-set of the pages excluding the omitted pages and hiding the omitted pages from the display at the user interface.

20. The method as claimed in claim 18, wherein requesting the one or more pages of a node is independent of the other pages and nodes in the user interface.

21. The method as claimed in claim 18, wherein requesting the one or more pages specifies a sequence of the pages.

22. A system for managing node pagination for a graph data set including a user interface, the user interface comprising:
a summary display component for displaying a summary of at least a portion of a data set as a set of the nodes at a user interface including representations of pages of the nodes for selection;
a user input control for receiving a user selection of one or more pages of a node for loading and display at the user interface;
a content requester for retrieving the one or more pages of the node from a content controller at which pages are cached or retrieved from a backing store;
a content rendering component for loading and displaying the one or more pages at the user interface;
in response to de-selection of one or more pages in the display, hiding the pages of data for the node and un-loading the pages from the display at the user interface; and
in response to re-selection of one or more pages in the display, retrieving the pages from the content controller and re-loading the pages in the display at the user interface.

23. The system as claimed in claim 22, wherein responsive to refreshing of a sub-set of previously selected pages, re-loading the sub-set of the pages excluding the omitted pages and hiding the omitted pages from the display at the user interface.
